(19) United States
(12) Patent Application Publication
(10) Pub. No.: US 2019/0376512 A1
(43) Pub. Date: Dec. 12, 2019

(54) PUMP APPARATUS

(71) Applicant: Nidec Tosok Corporation, Zama-shi, Kanagawa (JP)

(72) Inventors: Yoshiyuki KOBAYASHI, Zama-shi (JP); Kazuhiro HOMMA, Zama-shi (JP); Koji HIGUCHI, Zama-shi (JP); Yosuke ITO, Zama-shi (JP)

(21) Appl. No.: 16/486,178

(22) PCT Filed: Feb. 23, 2018
(86) PCT No.: PCT/JP2018/006608

§ 371 Date: Aug. 15, 2019

(30) Foreign Application Priority Data
Mar. 3, 2017 (JP) 2017-040683

(51) Int. Cl. F04C 15/00; H02K 5/20; H02K 9/19; H02K 11/33

(52) U.S. Cl. CPC F04C 15/0096; H02K 5/20; F04C 15/008; H02K 11/33; H02K 9/19

(57) ABSTRACT

A pump apparatus includes a motor including a shaft disposed along a central axis extending in an axial direction a pump that is located on one side of the motor in the axial direction, is driven by the motor via the shaft, and discharges an oil and an inverter circuit that is positioned on an outer side of the motor in a radial direction. The motor includes a rotor rotatable around the shaft, a stator facing the rotor, and a housing accommodating the rotor and the stator. The housing includes a heat sink that is located on an outer surface and includes a first flow channel to cause the oil delivered from the pump to flow. The inverter circuit comes into thermal contact with the heat sink.

### CROSS REFERENCE TO RELATED APPLICATIONS

This is a U.S. national stage of PCT Application No. PCT/JP2018/006608, filed on Feb. 23, 2018, and priority under 35 U.S.C. § 119(a) and 35 U.S.C. § 365(b) is claimed from Japanese Application No. 2017-040683, filed Mar. 3, 2017, the entire disclosures of each application are hereby incorporated herein by reference.

### 1. FIELD OF THE INVENTION

The present invention relates to a pump apparatus.

### 2. BACKGROUND

Recently, electric oil pumps used for transmissions and the like have been required to have responsiveness. In order to realize responsiveness in an electric oil pump, there is a need to increase the output of a motor for an electric oil pump.

When a motor for an electric oil pump has a high output, there is a need for an inverter for driving the motor to be designed to be able to withstand a high output. That is, there is a need to provide an inverter using an element which can withstand a large current. When a large current flows in the inverter, there is a concern that the element will radiate heat and the temperature of the inverter will rise. Therefore, in order to curb a temperature rise in the inverter, there is a need to provide an electric oil pump with a structure for preventing an increase in temperature.

Japanese Patent Laid-open No. 2005-229658 discloses an electric pump unit in which a motor rotor is firmly fixed to one end side of a shaft and is accommodated inside a motor case, and an input side gear is firmly fixed to the other end side of the shaft and is accommodated inside a motor flange blocking the motor case.

This electric pump unit disclosed in Japanese Patent Laid-open No. 2005-229658 has the motor case and a casing below a motor, and a circuit board (inverter circuit) serving as a controller is accommodated inside this casing. Therefore, since the circuit board (inverter circuit) is positioned below the motor, it is less likely to be affected by heat from the motor.

### SUMMARY

However, a casing has no means for releasing heat generated from an electronic component mounted in a circuit board (inverter circuit). Therefore, there is concern that heat will be confined inside the casing and the temperature of the circuit board (inverter circuit) will rise.

Example embodiments of the present disclosure provide pump apparatuses in each of which increases in temperature in a circuit board (inverter circuit) due to heat generated from an electronic component are prevented.

According to an example embodiment of the present disclosure, a pump apparatus includes a motor including a shaft rotatably supported about a central axis extending in an axial direction, a pump that is positioned on one side of the motor in the axial direction, is driven by the motor via the shaft, and discharges an oil, and an inverter circuit that is positioned on an outer side of the motor in a radial direction. The motor includes a rotor rotatable around the shaft, a stator disposed to face the rotor, and a housing accommodating the rotor and the stator. The housing includes a heat sink on an outer surface. The heat sink includes a first flow channel to cause the oil delivered from the pump to flow. The inverter circuit comes into thermal contact with the heat sink.

According to an example embodiment of the present disclosure, it is possible to provide a pump apparatus in which an increase in temperature in a controller due to heat generated from a circuit board (inverter circuit) is prevented.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view of a pump apparatus according to a first example embodiment of the present disclosure.

FIG. 2 is a perspective view of a portion of a heat sink provided in the pump apparatus according to the first example embodiment of the present disclosure.

FIG. 3 is a cross-sectional view of a pump apparatus according to a second example embodiment of the present disclosure.

FIG. 4 is a cross-sectional view of a pump apparatus according to a third example embodiment of the present disclosure.

FIGS. 5A-5C are views illustrating cooling structures of inverter circuits in which a heat dissipation member is provided.

FIGS. 6A and 6B are views illustrating modification examples of the pump apparatuses in which the inverter circuit is disposed at a position spaced away from a motor section.

FIGS. 7A-7C are views illustrating heat dissipation structures of heat radiation elements subjected to surface-mounting on the inverter circuits.

FIGS. 8A-8C are views illustrating additional heat dissipation structures of the heat radiation elements subjected to insertion-mounting in the inverter circuits.

FIGS. 9A and 9B are views describing positional relationships between the heat radiation elements provided in the inverter circuits and a stator of the motor.

### DETAILED DESCRIPTION

Hereinafter, with reference to the drawings, pump apparatuses according to example embodiments of the present disclosure will be described. However, it is intended that dimensions, materials, shapes, relative dispositions, and the like of constituent components disclosed as the example embodiments or illustrated in the drawings are merely explanatory examples and do not limit the scope of the present disclosure to the details described above. For example, expressions expressing relative or unique dispositions such as “in a certain direction”, “along a certain direction”, “parallel”, “orthogonal”, “center”, “concentric”, and “coaxial” express not only such dispositions in a strict sense but also express states relatively displaced with a tolerance, or at an angle or a distance to the extent that the same functions can be achieved. For example, expressions expressing states where subjects are equivalent to each other, such as “the same”, “equal”, and “homogeneous” express not only equivalent states in a strict sense but also express states having a tolerance or a difference to the extent that the same functions can be achieved is present. For example, expressions expressing shapes such as a quadrangular shape and a cylindrical shape express not only the shapes of a quadrangular shape and a cylindrical shape in a geometrically strict sense but also express shapes including uneven portions, chamfered portions, and the like within a range in which the same effects can be achieved. On the other hand, expressions such as “consisting of”, “equipped with”, “provided with”, “including”, and “having” a constituent element are not exclusive expressions excluding the presence of other constituent elements.

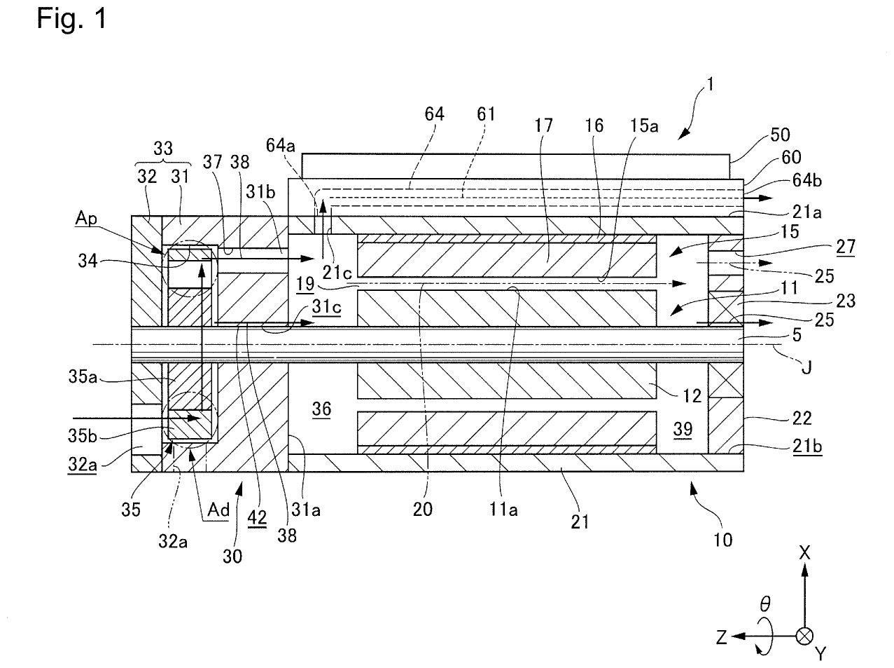

In addition, in the drawings, an XYZ coordinate system is suitably indicated as a three-dimensional orthogonal coordinate system. In the XYZ coordinate system, a Z-axis direction is a direction parallel to one direction in an axial direction of a central axis J illustrated in FIG. 1. An X-axis direction is a direction parallel to a width direction of a pump apparatus illustrated in FIG. 1, that is, an up-down direction in FIG. 1. A Y-axis direction is a direction orthogonal to both the X-axis direction and the Z-axis direction.

In addition, in the following description, a positive side in the Z-axis direction (positive Z-side) will be referred to as “a front side”, and a negative side in the Z-axis direction (negative Z-side) will be referred to as “a rear side”. The rear side and the front side are names simply used for description and do not limit actual positional relationships or directions. In addition, unless otherwise specified, the direction (Z-axis direction) parallel to the central axis J will be simply referred to as “an axial direction”. A radial direction about the central axis J will be simply referred to as “a radial direction”. A circumferential direction about the central axis J, that is, a direction (θ-direction) around the central axis J will be simply referred to as “a circumferential direction”.

In this specification, the expression “extending in the axial direction” includes a case of extending in a direction inclined within a range of less than 45° with respect to the axial direction, in addition to the case of strictly extending in the axial direction (Z-axis direction). In addition, in this specification, the expression “extending in the radial direction” includes a case of extending in a direction inclined within a range of less than 45° with respect to the radial direction, in addition to the case of strictly extending in the radial direction, that is, a direction perpendicular to the axial direction (Z-axis direction).

### First Example Embodiment

FIG. 1 is a cross-sectional view of a pump apparatus of a first example embodiment.

As illustrated in FIG. 1, a pump apparatus 1 of the present example embodiment has a motor section 10, a pump section 30, and an inverter circuit 50. The motor section 10 has a shaft disposed along the central axis J extending in the axial direction. The pump section 30 is positioned on one side of the motor section 10 in the axial direction, is driven by the motor section 10 via the shaft 5, and discharges an oil. That is, the motor section 10 and the pump section 30 are provided side by side along the axial direction.

The motor section 10 has a rotor 11, a stator 15, and a housing 21. The rotor 11 is fixed to an outer circumferential surface of the shaft 5 and rotates around the shaft 5. The stator 15 is disposed on an outer side of the rotor 11 in the radial direction. Therefore, the motor section 10 is an inner rotor motor.

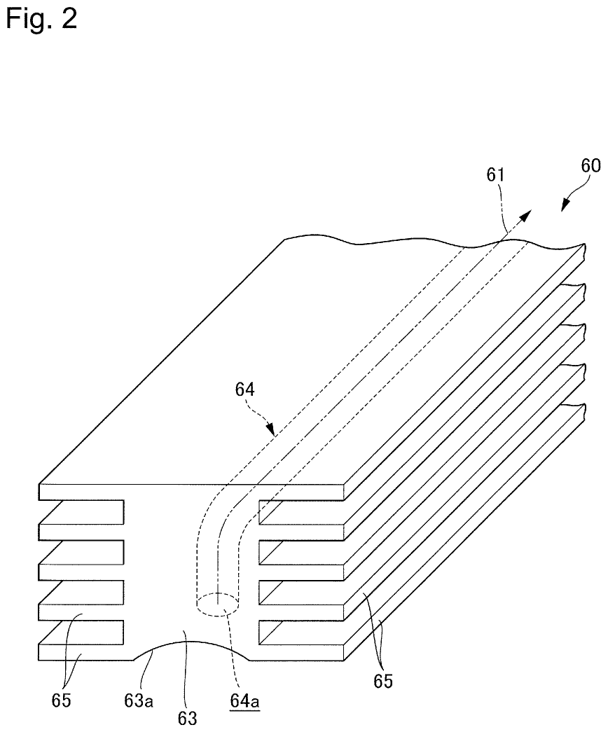

The housing 21 accommodates the rotor 11 and the stator 15. In the housing 21, the front side (positive Z-side) and the rear side (negative Z-side) are open, and a bearing holding portion 22 is inserted into an opening portion of the housing 21 on the rear side. A heat sink 60 is provided on an outer surface 21a of the housing 21 while being in contact therewith. A penetration hole 64 through which an oil can circulate as illustrated in FIG. 2 is provided inside the heat sink 60. The inverter circuit 50 comes into thermal contact with the heat sink 60. The penetration hole 64 is a flow channel for causing an oil delivered from the pump section 30 to flow into the heat sink 60. This flow channel of the penetration hole 64 will be referred to as a first flow channel 61. Hereinafter, each component will be described in detail.

### <Housing>

As illustrated in FIG. 1, the housing 21 has a tubular shape. In more detail, the housing 21 has a cylindrical shape in which both ends about the central axis J are open. The material of the housing 21 is a metal, for example. The housing 21 holds the motor section 10.

The bearing holding portion 22 is fitted into and attached to an opening portion 21b of the housing 21 on the other end side in the axial direction. A motor side discharge port 27 and a bearing 23 are provided in the bearing holding portion 22. An end portion of the shaft 5 on the other side in the axial direction is inserted into the bearing 23, and the bearing 23 supports the end portion of the shaft 5 on the other side in the axial direction. An end portion of the housing 21 on one side in the axial direction is connected in a state of being in contact with a bottom surface 31a of a pump body 31 of the pump section 30.

An outer surface of the stator 15, that is, an outer surface of a core back portion 16 (which will be described below) is fitted onto an inner surface of an intermediate portion of the housing 21 in the axial direction. Therefore, the stator 15 is held in the housing 21.

### <Rotor>

The rotor 11 has a rotor core 12 and a rotor magnet. The rotor core 12 surrounds the shaft 5 in the direction (θ-direction) around the axis and is fixed to the shaft 5. The rotor magnet is fixed to an outer circumferential portion of the rotor core 12 along the direction around the axis. The rotor core 12 and the rotor magnet rotate integrally with the shaft 5.

### <Stator>

The stator 15 surrounds the rotor 11 in the direction (θ-direction) around the axis and rotates the rotor 11 around the central axis J. The stator 15 has the core back portion 16, teeth portions 17, coils (not illustrated), and insulators (bobbins) (not illustrated). The shape of the core back portion 16 is a concentrically cylindrical shape with respect to the shaft 5.

The teeth portions 17 extend toward the shaft 5 from the inner surface of the core back portion 16. A plurality of teeth portions 17 are provided to be disposed at equal intervals in the circumferential direction of the inner surface of the core back portion 16. The coil is constituted of a conductive wire (not illustrated) wound around the teeth portion 17. The coil is provided in the insulator (bobbin). The insulator (bobbin) is mounted in each teeth portion 17.

### <Heat Sink>

As illustrated in FIGS. 1 and 2, the heat sink 60 comes into contact with the outer surface 21a of the housing 21 of the motor section 10 and extends along the axial direction of the housing 21. For example, the heat sink 60 is made by performing extrusion molding of a metal such as aluminum. In the example embodiment illustrated in FIG. 2, the heat sink 60 has a heat sink main body portion 63 formed to have a rectangular parallelepiped shape, and a plurality of heat dissipation plates 65 protruding outward from both sides of the heat sink main body portion 63. In the heat sink main body portion 63, a recessed portion 63a with which the outer surface 21a of the housing 21 comes into contact is provided in a bottom portion thereof. The recessed portion 63a has a curved surface curved along the outer surface 21a of the housing 21. Therefore, the heat sink 60 can be fixed in a state of adhering to the housing 21.

That is, the heat sink 60 is a separate member which is separate from the housing 21 and comes into thermal contact with the housing 21. The heat sink 60 is not limited to a case of directly coming into contact with the housing 21. The heat sink 60 may come into contact with the housing 21 via an insulating heat dissipation member (details will be described below). Moreover, the heat sink 60 may be provided to have a gap with respect to the housing 21. In this case, heat generated from the stator 15 is transferred to the heat sink 60 due to radiation heat. Therefore, even when the heat sink 60 is disposed in a non-contact state with respect to the housing 21, it is possible to state that the heat sink 60 is in thermal contact with the housing 21. In addition, the heat sink 60 is not limited to being separate from the housing 21, and the heat sink 60 and the housing 21 may be a part of a single member.

The penetration hole 64 is provided inside the heat sink main body portion 63, while having a first opening portion 64a which is one end open on one side in the axial direction of the surface of the recessed portion 63a, and a second opening portion 64b which is the other end on the other end side through the inside of the heat sink main body portion 63 and is open on the other end surface of the heat sink main body portion 63. An oil flows inside this penetration hole 64. The first opening portion 64a is provided in the housing 21 and is disposed to face a communication hole 21c.

A plurality of heat dissipation plates 65 are formed to have a rectangular shape in a plan view and are provided on side surfaces of the heat sink main body portion 63 at intervals in the up-down direction. The heat sink main body portion 63 may have the heat dissipation plates 65 on only one of the side surfaces on both sides. In addition, a plurality of heat dissipation plates 65 may be provided on the side surfaces of the heat sink main body portion 63 while extending in the up-down direction at intervals in the axial direction of the heat sink main body portion 63.

### <Inverter Circuit>

The inverter circuit 50 is realized by mounting a heat radiation element on a circuit board. The inverter circuit 50 supplies power for driving to the coils of the stator 15 of the motor section 10 and controls an operation of the motor section 10, such as driving, rotation, or stopping. The inverter circuit and the coils are electrically connected to each other to perform power supply and communication using electrical signals between the inverter circuit and the coils of the stator 15 through a wiring member such as a coated cable (not illustrated). In the example embodiment illustrated in FIG. 1, the inverter circuit 50 extends in a flat plate shape. The inverter circuit 50 is fixed to adhere to the top of the heat sink 60. That is, the inverter circuit 50 comes into thermal contact with the heat sink 60.

The inverter circuit 50 is not limited to a case of directly coming into contact with the heat sink 60. The inverter circuit 50 may come into contact with the heat sink via an insulating heat dissipation member (details will be described below). Moreover, the inverter circuit 50 may be provided to have a gap with respect to the heat sink 60. In this case, heat generated from the inverter circuit 50 is transferred to the heat sink 60 due to radiation heat. Therefore, even when the inverter circuit 50 is disposed in a non-contact state with respect to the heat sink 60, it is possible to state that the inverter circuit 50 is in thermal contact with the heat sink 60. Electronic components mounted on the inverter circuit 50 include a heat radiation element (which will be described below) which is likely to radiate heat.

### <Pump Section>

The pump section 30 is positioned on one side of the motor section 10 in the axial direction, in detail, on the front side (positive Z-axis side). The pump section 30 is driven by the motor section 10 via the shaft 5. The pump section 30 has the pump body 31, a pump rotor 35, and a pump cover 32. Hereinafter, the pump cover 32 and the pump body 31 will be referred to as a pump case 33.

The pump body 31 is fixed to the end portion of the housing 21 on the front side of the motor section 10. The pump body 31 has a pump chamber 34 which is depressed to the rear side (negative Z-side) from the surface on the front side (positive Z-side) and accommodates the pump rotor 35. The shape of the pump chamber 34 viewed in the axial direction is a circular shape.

The pump body 31 is open at both ends in the axial direction to allow the shaft 5 to pass therethrough and has a penetration hole 31c in which an opening on the front side is open in the pump chamber 34. An opening of the penetration hole 31c on the rear side is open on the motor section 10 side. The penetration hole 31c functions as a bearing member which rotatably supports the shaft 5.

The pump rotor 35 is attached to the shaft 5. In more detail, the pump rotor 35 is attached to the end portion of the shaft 5 on the front side. The pump rotor 35 has an inner rotor 35a which is attached to the shaft 5 and an outer rotor 35b which surrounds the outer side of the inner rotor 35a in the radial direction. The inner rotor 35a has a ring shape. The inner rotor 35a is a gear having teeth on the outer surface in the radial direction.

The inner rotor 35a is fixed to the shaft 5. In more detail, the end portion of the shaft 5 on the front side is press-fitted into the inner rotor 35a. The inner rotor 35a rotates together with the shaft 5 in the direction (θ-direction) around the axis. The outer rotor 35b has a ring shape surrounding the outer side of the inner rotor 35a in the radial direction. The outer rotor 35b is a gear having teeth on the inner surface in the radial direction.

The inner rotor 35a and the outer rotor 35b mesh with each other, and the outer rotor 35b rotates when the inner rotor 35a rotates. That is, the pump rotor 35 rotates due to rotation of the shaft 5. In other words, the motor section 10 and the pump section 30 have the same rotation axis. Therefore, the electric oil pump can be prevented from having an increased size in the axial direction. In addition, when the inner rotor 35a and the outer rotor 35b rotate, the volume of a space between meshed parts of the inner rotor 35a and the outer rotor 35b changes. A region where the volume decreases becomes a pressurization region Ap, and a region where the volume increases becomes a negative pressure region Ad. A pump side suction port 32a is disposed on one side of the negative pressure region Ad of the pump rotor 35 in the axial direction. In addition, a pump side discharge port 32b is disposed on one side of the pressurization region Ap of the pump rotor 35 in the axial direction. Here, an oil which has been suctioned into the pump chamber 34 through the pump side suction port 32a is accommodated in a volume part between the inner rotor 35a and the outer rotor 35b and is sent to the pump side discharge port 32b side. Thereafter, the oil is discharged through the pump side discharge port 32b.

A delivery hole 37 connecting the pump chamber 34 and the inside of the motor section 10 to each other is provided in the pump body 31. The opening of the delivery hole 37 on the pump chamber 34 side leads to the pressurization region Ap of the pump rotor 35. On the other hand, the opening of the delivery hole 37 on the motor section 10 side, that is, a pump side delivery port 31b leads to a space portion 36 inside the motor section 10. That is, the delivery hole 37 leads to the pump side delivery port 31b and the pressurization region Ap of the pump rotor 35. Therefore, an oil inside the pump section 30 is delivered to the inside of the space portion 36 through the pump side delivery port 31b via the delivery hole 37 due to pressurization of the pump section 30. Here, a flow channel for delivering an oil to the inside of the motor section 10 through the pump side delivery port 31b using pressurization of the pump section 30 will be referred to as a fifth flow channel 38. The space portion 36 indicates a region which is on one side of the motor section 10 in the axial direction and is surrounded by the housing 21, the pump body 31, the stator 15, and one end portion of the rotor 11 in the axial direction.

The pump cover 32 is attached to the front side of the pump body 31. The pump cover 32 has a disk shape extending in the radial direction. The pump cover 32 blocks the opening of the pump chamber 34 on the front side.

The pump section 30 has the pump side suction port 32a. The pump side suction port 32a is provided in the pump cover 32. The pump side suction port 32a leads to the negative pressure region Ad of the pump chamber 34 and allows an oil to be suctioned into the pump chamber 34. The pump side suction port 32a may be provided on a surface facing the side surface of the pump rotor 35 of the pump body 31 which accommodates the pump rotor 35 provided inside the pump section 30. In this case, an oil flows into the negative pressure region of the pump rotor from both sides of the pump rotor 35 in the axial direction due to a negative pressure generated in accordance with rotation of the pump rotor 35. Thus, an oil can be efficiently suctioned into the pump section 30.

In the pump apparatus 1 of the present example embodiment, when the shaft 5 rotates in one direction (negative θ-direction) in the circumferential direction, an oil is suctioned into the pump chamber 34 through the pump side suction port 32a. The oil which has been suctioned into pump chamber 34 is sent to the delivery hole 37 side by the pump rotor 35. The oil which has been sent to delivery hole 37 side passes through the fifth flow channel 38, that is, the delivery hole 37 and is delivered to the inside of the motor section 10 through the pump side delivery port 31b. Thereafter, the oil flows inside the heat sink 60 through the first flow channel 61. Therefore, the inverter circuit 50 can be cooled by the oil.

Next, a cooling structure of the inverter circuit 50 of the pump apparatus 1 according to the present example embodiment will be described. In the present example embodiment, an oil which has been supplied from an external apparatus flows to the delivery hole 37 through the pump side suction port 32a by the pump rotor 35 and circulates inside the heat sink 60 via the motor section 10, thereby realizing cooling of the inverter circuit 50.

### <First Flow Channel>

The first flow channel 61 causes an oil which has been delivered from the pump section 30 to flow inside the heat sink 60. In the example embodiment illustrated in FIGS. 1 and 2, the first flow channel 61 is provided between the first opening portion 64a and the second opening portion 64b of the penetration hole 64. In detail, the first flow channel 61 extends to the positive side in the X-axis direction from the first opening portion 64a, is bent to the other side in the axial direction, and extends to the other side in the axial direction along the longitudinal direction of the heat sink main body portion 63. The first opening portion 64a is open in a circular shape, is disposed to face the communication hole 21c, and communicates with the communication hole 21c. Therefore, the first flow channel 61 leads to the space portion 36 via the communication hole 21c. Thus, the pump side delivery port 31b leads to the first flow channel 61 via the space portion 36 and the communication hole 21c.

Therefore, an oil which has passed through the delivery hole 37 of the pump section 30 and has been delivered to the inside of the space portion 36 through the pump side delivery port 31b moves to the inside of the space portion 36. Thereafter, the oil is introduced into the heat sink 60 through the first flow channel 61 and flows inside the heat sink 60. Therefore, heat generated from the inverter circuit 50 which is in contact with (thermal contact with) the heat sink 60 is absorbed by the oil via the heat sink 60. Thus, the inverter circuit 50 can be cooled. In addition, since the inverter circuit 50 is positioned on the upstream side of the motor section 10 in an oil circulation direction, the inverter circuit 50 can be cooled by an oil before absorbing heat. Therefore, the inverter circuit 50 can be more efficiently cooled. In addition, since the heat sink 60 is in contact with the housing 21 of the motor section 10, heat generated from the motor section 10 is absorbed by an oil via the housing 21 and the heat sink 60. Therefore, the motor section 10 can be cooled. Thus, it is possible to realize the pump apparatus 1 in which a temperature rise in the inverter circuit 50 can be more efficiently curbed.

In the example embodiment illustrated in FIG. 1, a gap 19, that is, a fourth flow channel 20 for causing an oil to flow is provided between an inner circumferential surface 15a of the stator 15 and an outer circumferential surface 11a of the rotor 11. In addition, a space portion 39 is provided on the rear side of the other end of the motor section 10 in the axial direction, that is, in a region surrounded by the other end surface of the motor section 10 in the axial direction, the bearing holding portion 22, and the housing 21. Therefore, the fourth flow channel 20 connects the space portion 36 on the front side and the space portion 39 on the rear side to each other.

In addition, the motor side discharge port 27 for discharging an oil inside the motor section 10 is provided in the bearing holding portion 22. In the example embodiment illustrated in FIG. 1, the motor side discharge port 27 is provided in a circumferential edge portion of the bearing holding portion 22.

Therefore, an oil which has passed through the delivery hole 37 of the pump section 30 and has been delivered to the inside of the space portion 36 on the front side through the pump side delivery port 31b moves to the inside of the space portion 36 on the front side. Thereafter, the oil is introduced into the motor section 10 through the fourth flow channel 20. Therefore, the oil which has come into contact with the stator 15 absorbs heat generated from the stator 15. Thus, the motor section 10 can be more efficiently cooled. In addition, the rotor magnet can be prevented from being demagnetized.

The fourth flow channel 20 is not limited to being between the inner circumferential surface 15a of the stator 15 and the outer circumferential surface 11a of the rotor 11. The fourth flow channel 20 may be provided between the housing 21 and the stator 15. In this case, the fourth flow channel 20 may linearly extend or may spirally extend such that the fourth flow channel 20 advances in the circumferential direction of the stator 15 toward the axial direction on the outer surface of the stator 15. In addition, the fourth flow channel 20 may extend in a wave shape such that the fourth flow channel 20 changes the direction to the other side in the circumferential direction after changing the direction to one side in the circumferential direction of the stator 15 toward the axial direction on the outer surface of the stator 15.

In addition, in the example embodiment described above, a case where a flow channel for causing an oil to flow through the delivery hole 37 is the fifth flow channel 38 has been described. However, the fifth flow channel 38 may be a flow channel passing through a gap 42 between the shaft 5 passing through the penetration hole 31c provided in the pump body 31, and the penetration hole 31c. In this case, the delivery hole 37 is no longer present. An oil supplied from the pump rotor 35 flows into the gap 42 through the opening of the penetration hole 31c on the pump rotor 35 side, flows in the fifth flow channel 38, and flows into the motor section 10. When the gap 42 between the shaft 5 and the penetration hole 31c serves as the fifth flow channel 38, the structure of the pump body 31 is further simplified, and the manufacturing steps and the manufacturing costs of the pump section 30 can be prevented from increasing.

The fifth flow channel 38 is the gap 42 between the shaft 5 and the penetration hole 31c. Therefore, when the shaft 5 is supported via a bearing provided inside the penetration hole 31c, the fifth flow channel 38 may be in the bearing or in a gap between the bearing and the shaft 5.

In addition, in the example embodiment described above, a case where a sixth flow channel 25 is a flow channel for discharging an oil inside the motor section 10 through the motor side discharge port 27 has been described. However, the sixth flow channel 25 may be a flow channel passing through a gap between the shaft 5 passing through the bearing member provided in the bearing holding portion 22 and the bearing member. In the example embodiment illustrated in FIG. 1, the bearing member is the bearing 23. In this case, the motor side discharge port 27 is no longer present. An oil flowing in the fourth flow channel 20 between the rotor 11 and the stator 15 of the motor section 10 flows into the space portion 39. Thereafter, the oil flows into the gap between the shaft 5 and the bearing 23, that is, the sixth flow channel 25. When the gap between the shaft 5 and the bearing 23 serves as the sixth flow channel 25, the motor side discharge port 27 is no longer necessary. Therefore, the structure of the motor section is further simplified, and the manufacturing steps and the manufacturing costs of the motor section 10 can be prevented from increasing.

Since the sixth flow channel 25 is the gap between the shaft 5 and the bearing member, when the bearing member is the bearing 23, the sixth flow channel 25 may be in the bearing 23.

### Second Example Embodiment

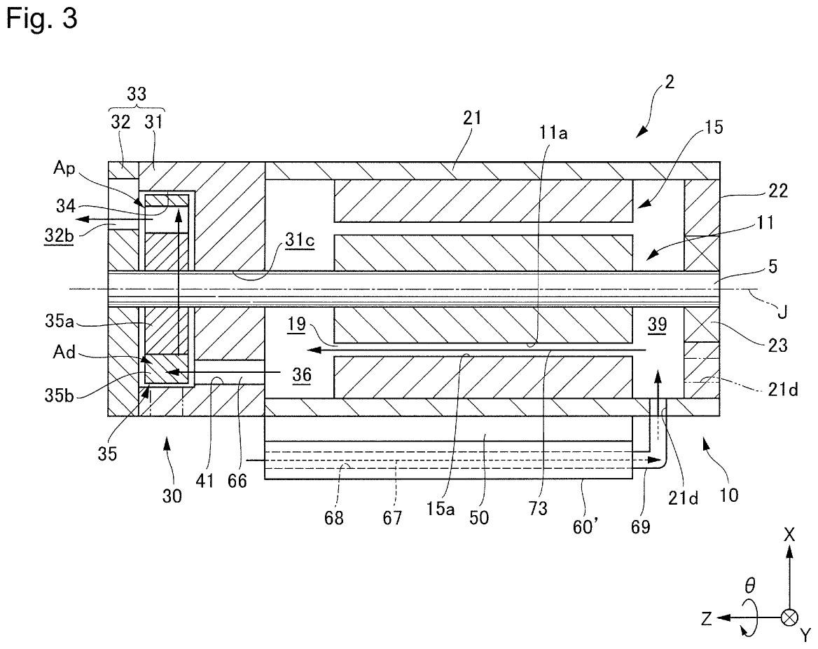

FIG. 3 is a cross-sectional view of a pump apparatus 2 according to a second example embodiment. In the second example embodiment, only the points different from the first example embodiment described above will be described. The same reference signs are applied to parts having the same form as the first example embodiment, and description thereof will be omitted.

As illustrated in FIG. 3, a heat sink 60′ has a second flow channel 67 for causing an oil delivered from the pump section 30 to flow. In the illustrated example embodiment, the heat sink 60′ has a penetration hole 68 penetrating the heat sink main body portion 63 from one end to the other end, and a flow channel for an oil flowing in this penetration hole 68 is the second flow channel 67.

In addition, the housing 21 has a motor side suction port 21d for suctioning an oil which has been delivered from the second flow channel 67, into the motor section 10. In the illustrated example embodiment, the motor side suction port 21d is provided on the side surface of the housing 21 and on the outside of the other end of the stator 15 in the axial direction. Therefore, the motor side suction port 21d communicates with the space portion 39 on the rear side. The second flow channel 67 and the motor side suction port 21d are connected to each other via a communication path 69.

The motor section 10 has a third flow channel 73 for causing an oil suctioned into the motor section 10 through the motor side suction port 21d to flow to the stator 15. In the illustrated example embodiment, regarding the third flow channel 73, the gap 19 provided between the inner circumferential surface 15a of the stator 15 and the outer circumferential surface 11a of the rotor 11 serves as the third flow channel 73.

A pump side introduction port 66 for introducing an oil inside the motor section 10 into the pump section 30 using a negative pressure in the pump section 30 is provided in the pump body 31 of the pump section 30. In the example embodiment illustrated in FIG. 3, the pump side introduction port 66 is open in a rear end portion of an introduction hole 41 connecting the negative pressure region Ad of the pump chamber 34 and the space portion 36 on the front side to each other. The pump side introduction port 66 is open in the space portion 36 on the front side of the motor section 10. The pump side discharge port 32b for discharging an oil flowing inside the pump section 30 is provided in the pump cover 32. The pump side discharge port 32b is open in the pressurization region Ap of the pump section. On the other hand, the pump side suction port 32a illustrated in FIG. 1 is not provided in the pump cover 32.

The inverter circuit 50 is provided on the outer surface 21a of the housing 21 while being in contact therewith along the axial direction of the housing 21. The heat sink 60′ is provided on the inverter circuit 50 while being in thermal contact therewith. In the illustrated example embodiment, the inverter circuit 50 is provided to be in direct contact with the heat sink 60′. The inverter circuit 50 is not limited to a case of directly coming into contact with the heat sink 60′. The inverter circuit 50 may come into contact with the heat sink 60′ via the insulating heat dissipation member (details will be described below). Moreover, the inverter circuit 50 may be provided to have a gap with respect to the heat sink 60′. In this case, heat generated from the inverter circuit 50 is carried by radiation heat and is transferred to the heat sink 60′. Therefore, even when the inverter circuit 50 is disposed in a non-contact state with respect to the heat sink 60′, it is possible to state that the inverter circuit 50 is in thermal contact with the heat sink 60′.

Therefore, an oil supplied from the pump section 30 flows in the second flow channel 67 of the heat sink 60, is discharged from the rear side of the second flow channel 67, and is introduced into the space portion 39 on the rear side via the communication path 69 and the motor side suction port 21d. The oil which has been introduced into the space portion 39 flows in the third flow channel 73 and is introduced into the pump section 30 through the introduction hole 41. The oil which has been introduced into the pump section 30 flows inside the pump section 30 and is discharged through the pump side discharge port 32b.

Therefore, when an oil flows in the second flow channel 67, the inverter circuit 50 can be cooled by the oil via the heat sink 60. In addition, an oil which has flowed out from the second flow channel 67 flows into the motor section 30 through the motor side suction port 21d. Therefore, the oil comes into contact with the stator 15 so that the stator 15 can be cooled. Therefore, influence of heat generated from the stator 15 applied to the inverter circuit 50 is reduced, and a temperature rise in the inverter circuit 50 can be more efficiently curbed.

In addition, since the inverter circuit 50 is positioned on the upstream side of the motor section 10 in the oil circulation direction, the inverter circuit 50 can be cooled by an oil before absorbing heat. Therefore, the inverter circuit 50 can be more efficiently cooled.

In the example embodiment described above, a case where the inverter circuit 50 comes into contact with the housing 21 has been described. However, the example embodiment is not limited thereto. For example, the heat sink 60 may be provided to come into contact with the housing 21, and the inverter circuit 50 may be provided to come into contact with the heat sink 60. In this case, since heat generated from the stator 15 can be more effectively cooled by the heat sink 60, it is possible to further reduce the degree of temperature rise in the inverter circuit 50 due to heat generated from the stator 15.

In addition, the motor side suction port 21d may be provided in the bottom portion of the housing provided in the other end portion of the housing 21 in the axial direction. In the illustrated example embodiment, the motor side suction port 21d may be provided in the bearing holding portion 22. In this case, since the stator 15 is positioned in front of an oil suctioned through the motor side suction port 21d, the oil which has flowed into the motor section 10 can be easily supplied to the inside of the third flow channel 73.

### Third Example Embodiment

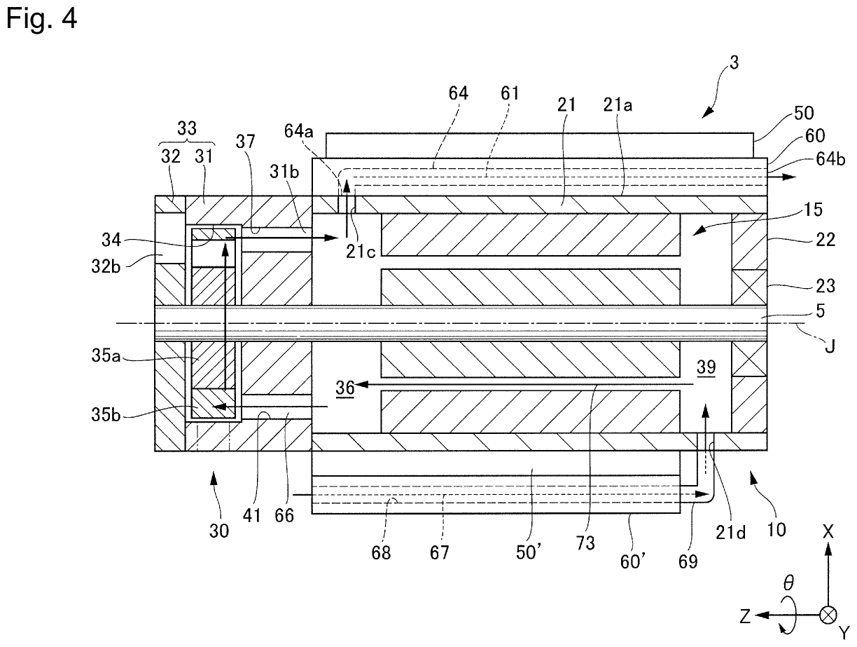

FIG. 4 is a cross-sectional view of a pump apparatus 3 according to a third example embodiment. The pump apparatus 3 of the third example embodiment is realized by combining the constitutions of the first example embodiment and the second example embodiment described above. Therefore, in the third example embodiment, the same reference signs are applied to parts having the same form as the first example embodiment and the second example embodiment, and description thereof will be omitted.

As illustrated in FIG. 4, the housing 21 further has an additional heat sink 60 which is separate from the heat sink 60′, on the outer surface 21a. The additional heat sink 60 has the first flow channel 61 for causing an oil delivered from the pump section 30 to flow. In addition, an additional inverter circuit 50 which is separate from an inverter circuit 50′ is disposed on the outer side of the motor section 10 in the radial direction. The additional inverter circuit 50 comes into thermal contact with the additional heat sink 60. The motor side discharge port 27 and the fourth flow channel 20 illustrated in FIG. 1 are not provided in the bearing holding portion 22 of the pump apparatus 3 illustrated in FIG. 4.

Therefore, in the pump apparatus 3 according to the third example embodiment, when the motor section 10 is driven, an oil supplied from the pump section 30 flows in the second flow channel 67 of the heat sink 60′ and is introduced into the space portion 39 on the rear side via the communication path 69 and the motor side suction port 21d. The oil introduced into the space portion 39 flows in the third flow channel 73 and is introduced into the pump section 30 through the introduction hole 41.

Therefore, when an oil flows in the second flow channel 67, the inverter circuit 50′ can be cooled by the oil via the heat sink 60′. In addition, the oil which has flowed out from the second flow channel 67 flows into the motor section 10 through the motor side suction port 21d. Therefore, the oil comes into contact with the stator 15 and cools the stator 15. Thus, a temperature rise in the inverter circuit 50′ can be more efficiently curbed.

In addition, an oil which has been introduced into the pump section 30 through the introduction hole 41 flows to the pump side discharge port 32b side inside the pump section 30. A part of the oil flowing to the pump side discharge port 32b side is delivered to the inside of the space portion 36 on the front side through the delivery hole 37 of the pump section 30 and then flows in the first flow channel 61 inside the additional heat sink 60. Therefore, heat generated from the additional inverter circuit 50 is absorbed by the oil via the heat sink 60. Therefore, a temperature rise in the additional inverter circuit 50 can be efficiently curbed.

### Modification Examples of First, Second, and Third Example Embodiments

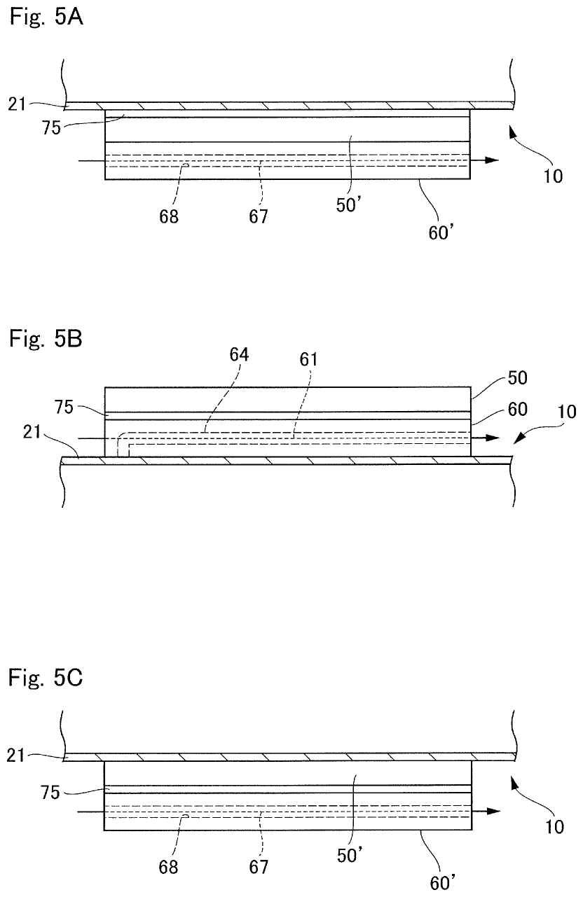

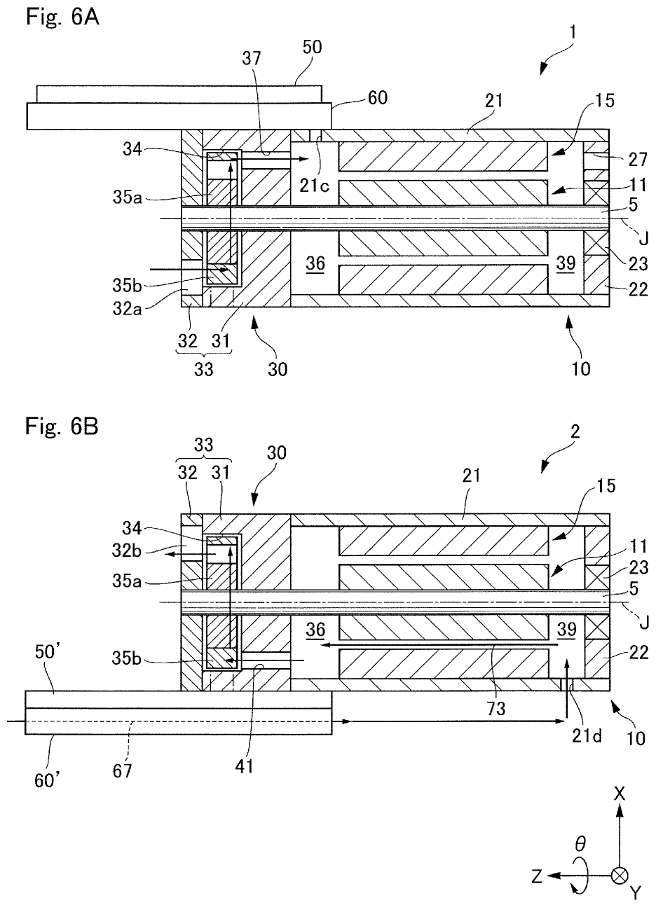

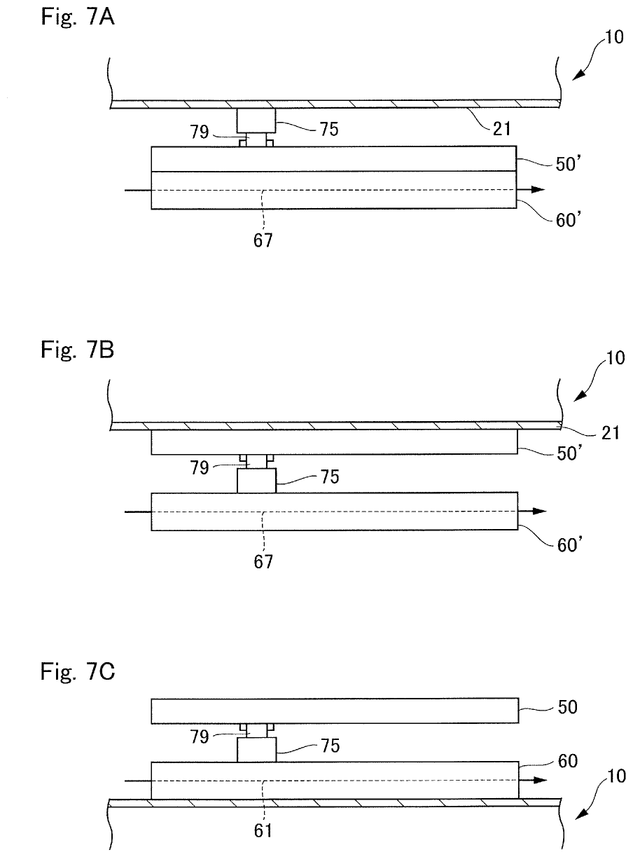

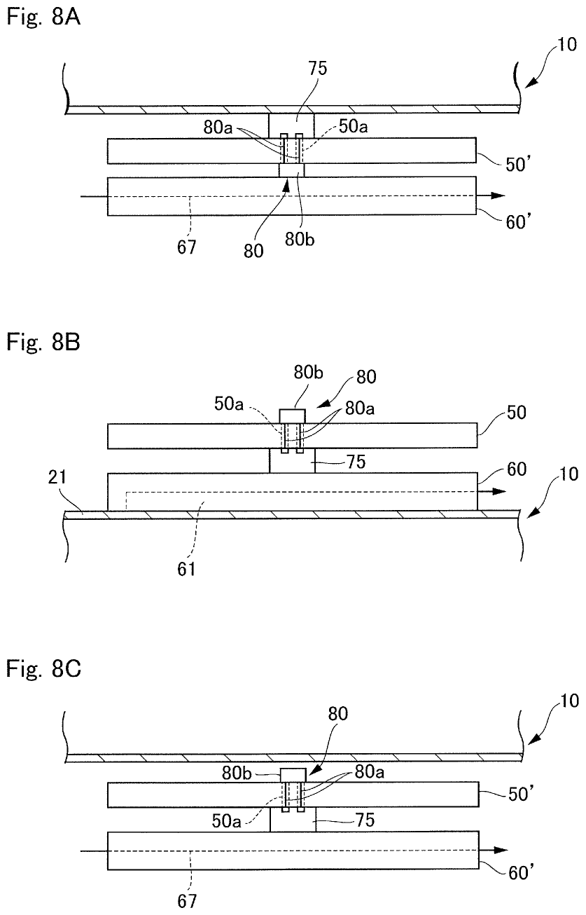

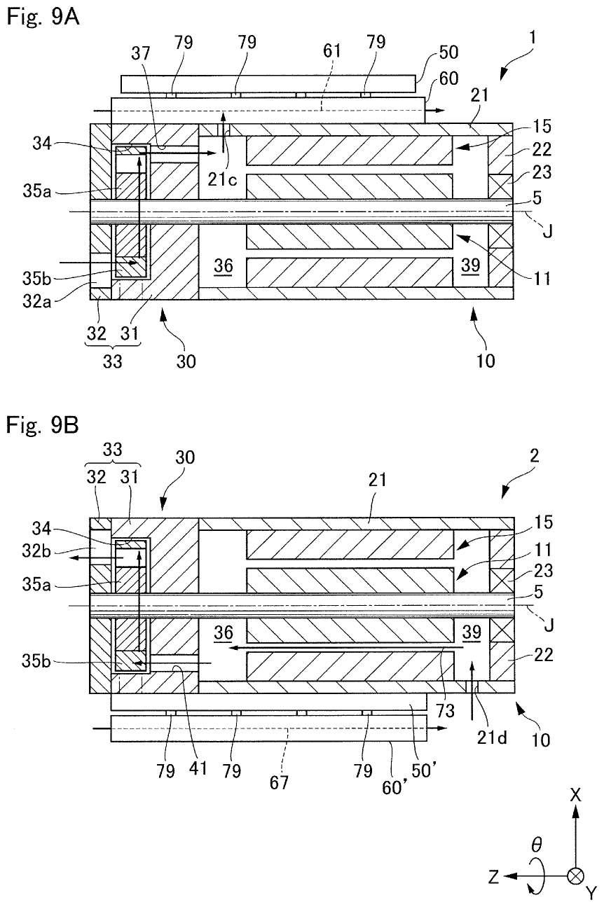

Next, modification examples of the pump apparatuses 1, 2, and 3 according to the first, second, and third example embodiments will be described. FIG. 5 is a view illustrating cooling structures of the inverter circuits 50 and 50′ provided in an insulating heat dissipation member 75. FIG. 6 is a view illustrating modification examples of the pump apparatuses 1 and in which the inverter circuits 50 and 50′ are disposed at positions away from the motor section 10, respectively. FIG. 7 is a view illustrating heat dissipation structures of heat radiation elements 79 subjected to surface-mounting on the inverter circuits 50 and 50′. FIG. 8 is a view illustrating the heat dissipation structures of the heat radiation elements 79 subjected to insertion-mounting in the inverter circuits 50 and 50′. FIG. 9 is a view for describing positional relationships between the heat radiation elements 79 provided in the inverter circuits 50 and 50′ and the stator 15 of the motor section 10.

In the second example embodiment and the third example embodiment described above, cases where the inverter circuit 50′ comes into contact with the housing 21 have been described. However, as illustrated in FIG. 5A, the inverter circuit 50′ may come into contact with the housing 21 via the insulating heat dissipation member 75. The insulating heat dissipation member 75 may be formed to have a sheet shape or a paste shape. In this manner, since the inverter circuit 50′ comes into contact with the housing 21 via the insulating heat dissipation member 75, the contact area between the inverter circuit 50′ and the housing 21 can be increased via the insulating heat dissipation member 75. Therefore, heat generated from the inverter circuit 50′ can be more efficiently dissipated to the motor section 10 side. Therefore, a temperature rise in the inverter circuit 50′ can be more efficiently curbed.

In addition, in the first example embodiment and the third example embodiment described above, cases where the inverter circuit 50 and the heat sink 60 come into contact with each other have been described. However, as illustrated in FIG. 5B, the inverter circuit 50 and the heat sink 60 may come into contact with each other via the insulating heat dissipation member 75. In this manner, since the inverter circuit 50 and the heat sink 60 come into contact with each other via the insulating heat dissipation member 75, the contact area between the inverter circuit 50 and the heat sink 60 can be increased. Therefore, heat generated from the inverter circuit 50 can be more efficiently dissipated to the heat sink 60 for cooling. Therefore, a temperature rise in the inverter circuit 50 can be more efficiently curbed.

In addition, in the second example embodiment and the third example embodiment described above, cases where the inverter circuit 50′ comes into contact with the housing 21 and the heat sink 60′ have been described. However, as illustrated in FIG. 5C, the inverter circuit 50′ and the heat sink 60′ may come into contact with each other via the insulating heat dissipation member 75. In this manner, since the inverter circuit 50′ and the heat sink 60′ come into contact with each other via the insulating heat dissipation member 75, the contact area between the inverter circuit 50′ and the heat sink 60′ can be increased. Therefore, heat generated from the inverter circuit 50′ can be more efficiently dissipated to the heat sink 60′ for cooling. Therefore, a temperature rise in the inverter circuit 50′ can be more efficiently curbed.

Moreover, in the first example embodiment and the third example embodiment described above, cases where the heat sinks 60 and 60′ and the inverter circuits 50 and 50′ are provided within a range of the stator 15 in the axial direction have been described. However, as illustrated in FIG. 6A, the inverter circuits 50 and 50′ may be positioned on the pump section side of the pump section side end portion of the stator 15.

In the example embodiment illustrated in FIG. 6A, a case where the heat sink 60 is also positioned on the pump section side of the pump section side end portion of the stator 15 and no oil flows inside the heat sink 60 has been described. In this case, an oil introduced into the motor section 10 from the pump section 30 flow in the fourth flow channel 20 through the delivery hole 37 and is discharged through the motor side discharge port 27. Therefore, the inverter circuit 50 cannot be cooled by the oil. However, since the inverter circuit 50 is positioned on the pump section side of the pump section side end portion of the stator 15, the inverter circuit 50 is at a position away from the stator 15. Therefore, the temperature of the inverter circuit 50 can be prevented from rising due to heat generated from the stator 15.

In addition, in the second example embodiment and the third example embodiment described above, cases where the heat sink 60′ and the inverter circuit 50′ are provided within a range of the stator 15 in the axial direction on the outer surface of the housing 21 have been described. However, as illustrated in FIG. 6B, the inverter circuit 50′ may be positioned on the pump section side of the pump section side end portion of the stator 15.

In the example embodiment illustrated in FIG. 6B, the heat sink 60′ is also positioned on the pump section side of the pump section side end portion of the stator 15. In addition, an oil which has flowed into the second flow channel 67 of the heat sink 60′ can flow into the space portion 39 of the motor section 10 on the rear side through the second flow channel 67. In this manner, since the inverter circuit 50′ is positioned on the pump section side of the pump section side end portion of the stator 15, the heat sink 60′ and the inverter circuit 50′ are provided at positions where they do not overlap the stator 15 in the radial direction of the stator 15. Therefore, since the temperature of an oil flowing inside the heat sink 60′ can be further prevented from rising due to heat generated from the stator 15, a temperature rise in an oil before the temperature rises can be further prevented by cooling the stator 15. Therefore, a temperature rise in the inverter circuit 50′ can be more efficiently curbed.

In addition, in the first example embodiment, the second example embodiment, and the third example embodiment described above, the inverter circuits 50 and 50′ have been described. However, the heat radiation element 79 which is likely to radiate heat may be provided in the inverter circuits 50 and 50′, and the heat radiation element 79 may come into contact with the housing 21 via the insulating heat dissipation member 75.

As illustrated in FIG. 7A, the heat radiation element 79 to be subjected to surface-mounting on the inverter circuit 50′ is mounted to face the housing 21 side, and the insulating heat dissipation member 75 is provided between the heat radiation element 79 and the housing 21. The heat sink 60′ is provided in the inverter circuit 50′ while being in contact therewith. The heat radiation element 79 is an electrolytic capacitor or a shunt resistor, for example. In this case, heat generated from the heat radiation element 79 can be efficiently dissipated to the housing via the insulating heat dissipation member 75. Therefore, concern of increase in temperature in the inverter circuit 50′ due to heat from the heat radiation element 79 can be curbed. The insulating heat dissipation member 75 may be provided between the inverter circuit 50′ and the heat sink 60′. In this case, heat of the inverter circuit 50′ can be more efficiently transferred to the heat sink 60′.

In addition, as illustrated in FIG. 7B, the inverter circuit 50′ is provided in the housing 21 while being in contact therewith, the heat radiation element 79 to be subjected to surface-mounting on the inverter circuit 50′ is mounted to face the heat sink 60′ side, and the insulating heat dissipation member 75 is provided between the heat radiation element 79 and the heat sink 60′. In this case, heat generated from the heat radiation element 79 is efficiently dissipated to the heat sink 60′ via the insulating heat dissipation member 75 and is absorbed by an oil. Therefore, the heat radiation element 79 can be more efficiently cooled. Accordingly, concern of increase in temperature in the inverter circuit 50′ due to heat from the heat radiation element 79 can be curbed. The insulating heat dissipation member 75 may be provided between the inverter circuit 50′ and the housing 21. In this case, heat of the inverter circuit 50′ can be efficiently transferred to an oil flowing inside the motor section 10 via the housing 21.

In addition, as illustrated in FIG. 7C, the heat sink 60 is provided in the housing 21 while being in contact therewith, the heat radiation element 79 to be subjected to surface-mounting on the inverter circuit 50 is mounted to face the heat sink 60 side, and the insulating heat dissipation member 75 is provided between the heat radiation element 79 and the heat sink 60. In this case, heat generated from the heat radiation element 79 is efficiently dissipated to the heat sink 60 via the insulating heat dissipation member 75 and is absorbed by an oil. Therefore, the heat radiation element 79 can be more efficiently cooled. Accordingly, concern of increase in temperature in the inverter circuit 50 due to heat from the heat radiation element 79 can be curbed.

In addition, in the example embodiment described above, a case where the heat radiation element 79 is subjected to surface-mounting on the inverter circuits 50 and 50′ has been described. However, the example embodiment is not limited thereto. A heat radiation element 79′ may be subjected to insertion-mounting in the inverter circuits 50 and 50′. As illustrated in FIG. 8A, when the inverter circuit 50′ is provided in the housing 21 while being in contact therewith and the heat sink 60′ is provided in the inverter circuit 50′ while being in contact therewith, a heat radiation element 80 may be subjected to insertion-mounting from the heat sink 60′ side. FIG. 8A is depicted such that there is a gap between the inverter circuit 50′ and the housing 21 and between the inverter circuit 50′ and the heat sink 60′. However, actually, there is no gap.

In this case, a lead 80a (terminal) extending from the heat radiation element 80 penetrates a through-hole 50a formed in the inverter circuit 50′ and is soldered onto an electric circuit formed on the rear surface of the inverter circuit 50′. In addition, the terminal of the lead 80a which protrudes from the rear surface of the inverter circuit 50′ and is soldered comes into contact with the housing 21 via the insulating heat dissipation member 75. In addition, a main body 80b of the heat radiation element 80 comes into contact with the heat sink 60′. Therefore, heat generated from the heat radiation element 80 is efficiently dissipated to the housing 21 via the lead 80a of the heat radiation element 80, the through-hole 50a, the solder, and the insulating heat dissipation member 75, and heat is directly dissipated to the heat sink 60′ from the main body 80b of the heat radiation element 80. Therefore, concern of increase in temperature in the inverter circuit 50′ due to heat from the heat radiation element 80 can be efficiently curbed.

In addition, as illustrated in FIG. 8B, when the heat sink 60 is provided in the housing 21 while being in contact therewith and the inverter circuit 50 is provided in the heat sink 60, the heat radiation element 80 may be subjected to insertion-mounting from a side opposite to the heat sink 60 side. FIG. 8B is depicted such that there is a gap between the inverter circuit 50 and the heat sink 60. However, actually, there is no gap. In this case, the lead 80a (terminal) extending from the heat radiation element 80 penetrates the through-hole 50a formed in the inverter circuit 50 and is soldered onto the electric circuit formed on the rear surface of the inverter circuit 50. The end portion of the lead 80a which protrudes from the rear surface of the inverter circuit 50 and is soldered comes into contact with the heat sink 60 via the insulating heat dissipation member 75. Therefore, heat generated from the heat radiation element 80 can be efficiently dissipated to the heat sink 60 via the lead 80a of the heat radiation element 80, the through-hole 50a, the solder, and the insulating heat dissipation member 75. Therefore, concern of increase in temperature in the inverter circuit 50 due to heat from the heat radiation element 80 can be efficiently curbed.

In addition, as illustrated in FIG. 8C, when the inverter circuit 50′ is provided in the housing 21 while being in contact therewith and the heat sink 60′ is provided in the inverter circuit 50′, the heat radiation element 80 may be subjected to insertion-mounting from the housing 21 side. FIG. 8C is depicted such that there is a gap between the inverter circuit 50′ and the housing 21 and between the inverter circuit 50′ and the heat sink 60′. However, actually, there is no gap. In this case, the lead 80a (terminal) extending from the heat radiation element 80 penetrates the through-hole 50a formed in the inverter circuit 50′ and is soldered onto the electric circuit formed on the rear surface of the inverter circuit 50′. The end portion of the lead 80a which protrudes from the rear surface of the inverter circuit 50′ and is soldered comes into contact with the heat sink 60′ via the insulating heat dissipation member 75. Therefore, heat generated from the heat radiation element 80 can be efficiently dissipated to the heat sink 60′ via the lead 80a of the heat radiation element 80, the through-hole 50a, the solder, and the insulating heat dissipation member 75. Therefore, concern of increase in temperature in the inverter circuit 50′ due to heat from the heat radiation element 80 can be efficiently curbed.

In addition, as illustrated in FIG. 9A, the inverter circuit 50 may have a plurality of heat radiation elements 79, and at least a part of the plurality of heat radiation elements 79 may be positioned on the pump section side of the pump section side end portion of the stator 15. In the case illustrated in FIG. 9A, the heat sink 60 is provided in the housing 21 while being in contact therewith, and the inverter circuit 50 is provided in the heat sink 60. In addition, the plurality of heat radiation elements 79 are disposed on the heat sink 60 side of the inverter circuit 50 at intervals in the longitudinal direction of the heat sink 60. In the illustrated example embodiment, a case where there are four heat radiation elements 79 has been described as an example. Then, two heat radiation elements 79 disposed on the pump section 30 side of the plurality of heat radiation elements 79 are positioned on the pump section side of the pump section side end portion of the stator 15. Therefore, these two heat radiation elements 79 are positioned on the motor section 10 side of one end of the stator 15 in the axial direction. Therefore, the two heat radiation elements 79 are provided at positions away from the stator 15. Thus, since these two heat radiation elements 79 are cooled by an oil before being affected by heat from the stator 15, these two heat radiation elements 79 can be efficiently cooled.

In addition, as illustrated in FIG. 9B, the inverter circuit 50′ is provided in the housing 21 while being in contact therewith, and the heat sink 60′ is provided in the inverter circuit 50′. In addition, the plurality of heat radiation elements 79 are disposed on the heat sink 60′ side of the inverter circuit 50′ at intervals in the longitudinal direction of the heat sink 60′. In the illustrated example embodiment, a case where there are four heat radiation elements 79 has been described as an example. Then, two heat radiation elements 79 disposed on the pump section 30 side of the plurality of heat radiation elements 79 are positioned on the pump section 30 side of the pump section side end portion of the stator 15. Therefore, these two heat radiation elements 79 are positioned on the motor section side of one end of the stator 15 in the axial direction. Therefore, the two heat radiation elements 79 are provided at positions away from the stator 15. Thus, since these two heat radiation elements 79 are cooled by an oil before being affected by heat from the stator 15, these two heat radiation elements 79 can be efficiently cooled.

Hereinabove, preferable example embodiments of the present disclosure have been described. However, the present disclosure is not limited to these example embodiments, and various modifications and changes can be made within a range of the gist thereof.

In the first example embodiment described above, a case where the heat sink 60 comes into contact with the outer surface 21a of the housing 21 has been described. However, the heat sink may be provided while being in non-contact with the outer surface 21a of the housing 21. In this case, the influence of heat from the stator 15 with respect to the heat sink 60 is reduced. Therefore, the inverter circuit 50 can be more efficiently cooled by an oil flowing in the heat sink 60.

In the example embodiment described above, a case where the motor section 10 is an inner rotor motor has been described. However, the motor section 10 may be an outer rotor motor.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-22. (canceled)

23. A pump apparatus comprising:
a motor including a shaft disposed along a central axis extending in an axial direction;
a pump that is positioned on one side of the motor in the axial direction, is driven by the motor via the shaft, and discharges an oil; and
an inverter circuit that is positioned on an outer side of the motor in a radial direction; wherein
the motor includes:
a rotor rotatable around the shaft;
a stator disposed to face the rotor; and
a housing accommodating the rotor and the stator;
the housing includes a heat sink on an outer surface;
the heat sink includes a first flow channel to cause the oil delivered from the pump to flow; and
the inverter circuit comes into thermal contact with the heat sink.

24. A pump apparatus comprising:
a motor including a shaft rotatably supported about a central axis extending in an axial direction;
a pump that is positioned on one side of the motor in the axial direction, is driven by the motor via the shaft, and discharges an oil; and
an inverter circuit that is positioned on an outer side of the motor in a radial direction; wherein
the motor includes:
a rotor rotatable around the shaft;
a stator disposed to face the rotor; and
a housing accommodating the rotor and the stator;
the housing includes a heat sink on an outer surface;
the heat sink includes a second flow channel to cause the oil delivered from the pump to flow;
the motor further includes a motor side suction port to cause the oil delivered from the second flow channel into the motor;
the second flow channel is connected to the motor side suction port; and
the motor includes a third flow channel to cause the oil suctioned into the motor through the motor side suction port to flow to the stator.

25. The pump apparatus according to claim 24, wherein
the housing includes an additional heat sink that is separate from the heat sink on the outer surface;
the additional heat sink includes a first flow channel to cause the oil delivered from the pump to flow;
an additional inverter circuit that is separate from the inverter circuit is disposed on an outer side of the motor in the radial direction; and
the additional inverter circuit comes into thermal contact with the additional heat sink.

26. The pump apparatus according to claim 23, wherein the heat sink is separate from the housing and comes into thermal contact with the housing.

27. The pump apparatus according to claim 23, wherein
a pump side suction port to suction the oil into the pump is provided in the pump; and
the pump side suction port is provided in a negative pressure region of the pump.

28. The pump apparatus according to claim 27, wherein the pump side suction port is provided in a pump cover disposed to face a surface on one side in the axial direction of a pump rotor provided inside the pump.

29. The pump apparatus according to claim 27, wherein the pump side suction port is provided on a side surface of the pump.

30. The pump apparatus according to claim 23, wherein
a pump side delivery port to deliver the oil to the first flow channel is provided in the pump; and
the pump side delivery port is provided in a pressurization region of the pump.

31. The pump apparatus according to claim 30, wherein the pump side delivery port is provided in a pump body of the pump disposed to face the motor.

32. The pump apparatus according to claim 23, wherein the pump includes:
a pump body including a penetration hole through which the shaft passes and being disposed to face the motor;
a pump side delivery port to deliver the oil to the first flow channel; and
a fifth flow channel to deliver the oil to the inside of the motor through the pump side delivery port using pressurization of the pump; and
the fifth flow channel passes through a gap between the penetration hole and the shaft passing through the penetration hole.

33. The pump apparatus according to claim 30, wherein the pump side delivery port and the first flow channel are directly connected to each other.

34. The pump apparatus according to claim 30, wherein
the motor includes a space portion capable of being filled with the oil delivered through the pump side delivery port; and
the space portion and the first flow channel are connected to each other.

35. The pump apparatus according to claim 30, wherein
a fourth flow channel to cause the oil delivered through the pump side delivery port to flow is provided between the stator and the rotor; and
the fourth flow channel is connected to a motor side discharge port provided in the motor.

36. The pump apparatus according to claim 35, wherein the motor includes:
a sixth flow channel to discharge the oil inside the motor through the motor side discharge port; and
a bearing held by the other end portion of the housing in the axial direction and rotatably supporting the shaft; and
the sixth flow channel passes through a gap between the shaft and the bearing.

37. The pump apparatus according to claim 24, wherein the motor side suction port is provided on a side surface of the housing and on an outer side of the other end of the stator in the axial direction.

38. The pump apparatus according to claim 24, wherein the motor side suction port is provided in a bottom portion of the housing provided in the other end portion of the housing in the axial direction.

39. The pump apparatus according to claim 23, wherein the inverter circuit and the housing come into contact with each other via an insulating heat dissipator.

40. The pump apparatus according to claim 23, wherein the inverter circuit and the heat sink come into contact with each other via an insulating heat dissipator.

41. The pump apparatus according to claim 39, wherein a heat radiator provided in the inverter circuit comes into contact with the housing via the insulating heat dissipator.

42. The pump apparatus according to claim 40, wherein a heat radiator provided in the inverter circuit comes into contact with the heat sink via the insulating heat dissipator.
